(19) United States
(12) Patent Application Publication
(10) Pub. No.: US 2026/0311936 A1
(43) Pub. Date: Oct. 8, 2026

(54) ELECTROLYTIC CAPACITOR ELEMENT AND MANUFACTURING METHOD OF THE SAME

(71) Applicant: ELNA CO., LTD., Chuo-ku, Tokyo (JP)

(72) Inventors: Shinichiroh ITOH, Nishishirakawa-gun, Fukushima (JP); Tadahiro NAKAMURA, Nishishirakawa-gun, Fukushima (JP)

(21) Appl. No.: 19/479,223

(22) PCT Filed: Apr. 15, 2024
(86) PCT No.: PCT/JP2024/015003

§ 371 Date: Oct. 27, 2025

(30) Foreign Application Priority Data
May 12, 2023 (JP) 2023-079475

(51) Int. Cl. H01G 9/07; H01G 9/00; H01G 9/02; H01G 9/055

(52) U.S. Cl. CPC H01G 9/07; H01G 9/0032; H01G 9/02; H01G 9/055

(57) ABSTRACT

An electrolytic capacitor element includes a wound body in which an anode foil and a cathode foil are wound with a first separator and a second separator on opposite sides of each other, an anode connection terminal connected to a first position of the anode foil, a cathode connection terminal connected to a second position of the cathode foil, a first insulating material that is wound within the winding body so as to face the first position and the second position on the first separator, and a second insulating material that is wound in the winding body so as to face the first position and the second position on the second separator, and disposed on an opposite side of the first insulating material with the anode foil and the cathode foil interposed therebetween.

### TECHNICAL FIELD

The present invention relates to an electrolytic capacitor element and a manufacturing method of the electrolytic capacitor element.

### BACKGROUND ART

For example, in an electrolytic capacitor element, a technique is known in which the connection points between the wound anode and cathode foils and a pair of lead terminals are covered with insulating paper to prevent the separator between the anode and cathode foils from being damaged by the lead terminals (see, for example, Patent Documents 1 and 2).

### RELATED ART DOCUMENT

### Patent Document

Patent Document 1: Japanese Patent Application Laid-Open Publication No. 2006-286959
Patent Document 2: Japanese Patent Application Laid-Open Publication No. 2022-40754

### SUMMARY OF THE INVENTION

### Problems to be Solved by the Invention

For example, in a manufacturing method of an electrolytic capacitor element, when winding anode foil and cathode foil through a separator, insulating paper is placed on the separator to cover the connections between the anode foil and cathode foil and a pair of lead terminals. However, misalignment can occur due to various factors, such as the precision and vibration of the manufacturing equipment. If the connections are not properly covered by the insulating paper due to misalignment, the separator can be damaged by the lead terminals, potentially resulting in quality degradation such as short circuits.

The present invention has been developed in consideration of the above-mentioned issues, and aims to provide an electrolytic capacitor element and a manufacturing method of the electrolytic capacitor element that can suppress quality degradation.

### Means for Solving the Problems

An electrolytic capacitor element according to the present invention includes: a wound body in which an anode foil and a cathode foil are wound with a first separator and a second separator on opposite sides of each other; an anode connection terminal connected to a first position of the anode foil; a cathode connection terminal connected to a second position of the cathode foil; a first insulating material that is wound within the winding body so as to face the first position and the second position on the first separator; and a second insulating material that is wound in the winding body so as to face the first position and the second position on the second separator, and disposed on an opposite side of the first insulating material with the anode foil and the cathode foil interposed therebetween.

In the above-mentioned electrolytic capacitor element, a length of at least one of the first insulating material and the second insulating material in a winding direction may be three times or more a distance between the anode connection terminal and the cathode connection terminal.

In the above-mentioned electrolytic capacitor element, a length of at least one of the first insulating material and the second insulating material in a winding direction may be 10 times or less a distance between the anode connection terminal and the cathode connection terminal.

In the above-mentioned electrolytic capacitor element, at least one of the first insulating material and the second insulating material may contain a fiber.

In the above-mentioned electrolytic capacitor element, each of the anode connection terminal and the cathode connection terminal may have a burr at an end thereof that penetrates the anode foil and the cathode foil, respectively, and is crimped and connected to each of the anode foil and the cathode foil by the burr, and at least one of the first insulating material and the second insulating material may cover the burr of at least one of the anode foil and the cathode foil.

In the above-mentioned electrolytic capacitor element, the first insulating material may be attached to the first separator.

In the above-mentioned electrolytic capacitor element, the second insulating material may be attached to the second separator.

A manufacturing method of an electrolytic capacitor element according to the present invention includes: connecting an anode connection terminal to a first position of an anode foil and connecting a cathode connection terminal to a second position of a cathode foil; and winding the anode foil and the cathode foil with a first separator and a second separator interposed therebetween on opposite sides to form a wound body, wherein, in the forming of the wound body, a first insulating material is wound in the wound body so as to face the first position and the second position on the first separator, and a second insulating material is wound in the wound body on an opposite side to the first insulating material with the anode foil and the cathode foil sandwiched therebetween so as to face the first position and the second position on the second separator.

### Effects of the Invention

According to the present invention, deterioration in the quality of electrolytic capacitor element can be suppressed.

### BRIEF DESCRIPTION OF THE DRAWINGS

FIG. 1 is a side view of an example of an aluminum electrolytic capacitor.

FIG. 2 is a perspective view of an example of an electrolytic capacitor element.

FIG. 3 is a schematic cross-sectional view of an example of a winding structure of a wound body along line A-A in FIG. 2.

FIG. 4 is a cross-sectional view of an example of a winding structure near a battledore portion.

FIG. 5a is a front view of an outer surface of an anode foil unfolded in a winding direction.

FIG. 5a is a front view of an outer surface of a cathode foil unfolded in a winding direction.

FIG. 6a is a front view of an inner surface of an anode foil unfolded in a winding direction.

FIG. 6b is a front view of an inner surface of a cathode foil unfolded in a winding direction.

FIG. 7a is a front view of an outer surface of an anode foil when insulating sheets are individually placed at positions of an anode foil and a cathode foil.

FIG. 7b is a front view of an outer surface of a cathode foil when insulating sheets are individually placed at positions of an anode foil and a cathode foil.

FIG. 8 is a flowchart of an example of a manufacturing process for an aluminum electrolytic capacitor.

FIG. 9 is a diagram of an example of a schematic configuration of a winding device that produces a wound body.

FIG. 10 is a diagram of another example of a schematic configuration of a winding device that produces a wound body.

### DETAILED DESCRIPTION OF EMBODIMENTS

### Embodiment

### (Configuration of Aluminum Electrolytic Capacitor)

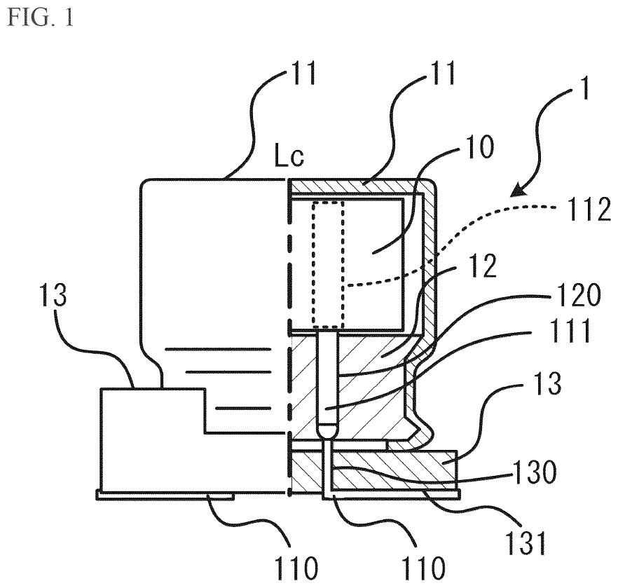

FIG. 1 is a side view of an example of an aluminum electrolytic capacitor 1. In the right half of FIG. 1, a cross section of the interior of the aluminum electrolytic capacitor 1 is illustrated across the center line Lc.

The aluminum electrolytic capacitor 1 is an example of an electrolytic capacitor, specifically a conductive polymer hybrid aluminum electrolytic capacitor. The aluminum electrolytic capacitor 1 is mounted on an electronic circuit board and is used for coupling, decoupling, smoothing, and other purposes.

The aluminum electrolytic capacitor 1 includes an electrolytic capacitor element 10, a case 11, a sealing body 12, a seat plate 13, a pair of battledore portions 112, a pair of round bar portions 111, and a pair of lead portions 110. The battledore portion 112, the round bar portion 111, and the lead portion 110 function as a lead electrode of the electrolytic capacitor element 10. The round bar portion 111 extends from the tip of the battledore portion 112, and the lead portion 110 extends from the tip of the round bar portion 111. While only one of the battledore portion 112 and the round bar portion 111 is illustrated in FIG. 1, the other battledore portion 112 and the other round bar portion 111 are provided symmetrically across the center line L.

The case 11 is made of aluminum and has a cylindrical shape with a closed top opening. The case 11 covers the electrolytic capacitor element 10 and the sealing body 12 and functions as the exterior of the aluminum electrolytic capacitor 1. The shape of the case 11 is not limited to a cylindrical shape and may also be a rectangular tube shape.

The sealing body 12 is a substantially cylindrical member made of an elastic material such as butyl rubber. The sealing body 12 is adjacent to the electrolytic capacitor element 10 and seals the opening at the bottom of the case 11.

As described below, the electrolytic capacitor element 10 is configured by overlapping and winding an anode foil, a cathode foil, and a separator (electrolytic paper). The pair of battledore portions 112 are disposed inside the electrolytic capacitor element 10, and the pair of round bar portions 111 extend from the bottom of the electrolytic capacitor element 10.

The battledore portion 112, the round bar portion 111, and the lead portion 110 are made of aluminum or the like. The pair of battledore portions 112 are crimped to the anode foil and the cathode foil, respectively, and function as the anode terminal and cathode terminal of the aluminum electrolytic capacitor 1. Each the round bar portions 111 is inserted into a pair of through holes 120 formed in the sealing body 12. Note that while only one of the through holes 120 is illustrated in FIG. 1, the other through hole 120 is located symmetrically across the center line L.

The lead portion 110 has a flat plate shape and is bent into an L-shape, with its tip extending along the surface of the seat plate 13. The round bar portion 111 side of the lead portion 110 is inserted into a through-hole 130 in the seat plate 13. The lead portion 110 is soldered to a pad on the electronic circuit board during the reflow process.

The seat plate 13 is a plate-like member made of resin or the like, and is provided below the case 11 and the sealing body 12. The seat plate 13 supports the case 11 and the sealing body 12 relative to the electronic circuit board on which the case 11 and the sealing body 12 are mounted. The seat plate 13 is provided with the through-hole 130 for the lead portion 110 and a groove 131 that accommodates the bent tip of the lead portion 110. The groove 131 extends outward from near the center along the bottom surface of the seat plate 13. The bottom surface of the seat plate 13 serves as the mounting surface for the aluminum electrolytic capacitor 1 on the electronic circuit board, allowing the plate-shaped lead portion 110 to be soldered to pads on the electronic circuit board. While this embodiment uses the surface-mount aluminum electrolytic capacitor 1, the embodiments described below can also be applied to lead types without the seat plate 13.

### (Configuration of Electrolytic Capacitor Element)

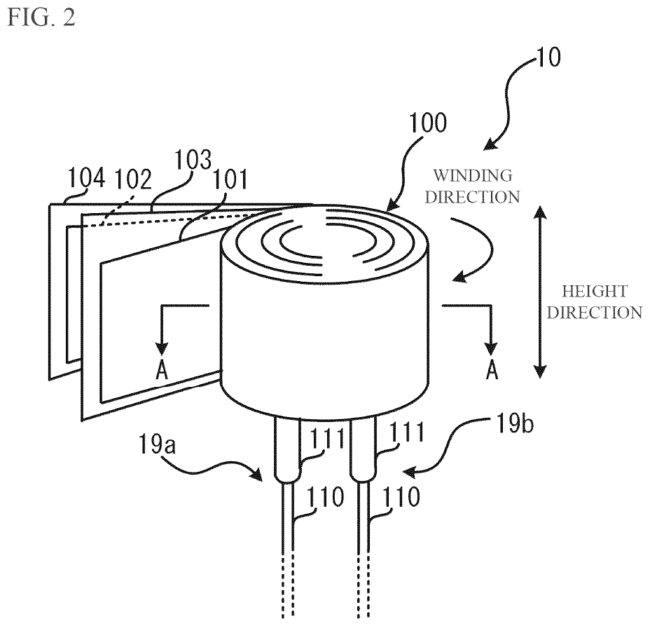

FIG. 2 is a perspective view of an example of the electrolytic capacitor element 10. In FIG. 2, components common to FIG. 1 are designated by the same reference numerals and will not be described again. FIG. 2 illustrates the lead portion 110 in its pre-bending state. The electrolytic capacitor element 10 includes a wound body 100 formed by winding an anode foil 101, a cathode foil 102, and separators (electrolytic paper) 103, 104, and a pair of lead electrodes 19a, 19b connected to the anode foil 101 and the cathode foil 102 respectively. The lead electrode 19a is an anode terminal, and the lead electrode 19b is a cathode terminal.

The anode foil 101 and the cathode foil 102 are made of valve metals such as aluminum, tantalum, titanium, or niobium, as well as alloy foils and vapor-deposited foils. The surface of the anode foil 101 is etched to increase the electrode area. This ensures that the electrolytic capacitor element 10 maintains a predetermined capacitance. Furthermore, an extremely thin oxide film is formed on the surface of the anode foil 101. This insulates the anode foil 101 from other components. The oxide film functions as a dielectric, allowing the electrolytic capacitor element 10 to function as a capacitor. The thickness of the anode foil 101 is, for example, 5 to 200 μm. This thickness range is preferable because the thickness range achieves an appropriate balance between the strength and capacitance of the anode foil 101.

On the other hand, no oxide film is formed on the surface of the cathode foil 102. The surface of the cathode foil 102 may also be etched. Additionally, an oxide coating, or an inorganic or carbon layer, may be formed on the surface of the cathode foil 102.

The separators 103, 104 are wound while sandwiched between the anode foil 101 and the cathode foil 102. The separators 103, 104 are made of at least one material selected from the group consisting of cellulose, rayon, and glass fiber. The wound body 100 is a substantially cylindrical element formed by winding the anode foil 101, the cathode foil 102, and the separators 103, 104. In this embodiment, the height direction of the electrolytic capacitor element 10 is defined along the height of this substantially cylindrical shape. The pair of lead electrodes 19a, 19b extend downward from the wound body 100 in the height direction. The height direction substantially coincides with the extension direction of the round bar portion 111 of each of the lead electrodes 19a, 19b.

During the manufacturing process of the aluminum electrolytic capacitor 1, the wound body 100 is immersed in a dispersion or solution of an electrolyte and a conductive polymer. This allows the separators 103, 104 to retain the electrolyte and conductive polymer layer. The thickness of the separators 103, 104 is, for example, 1 to 100 μm. This thickness range is preferable because the thickness range maintains a good balance between the strength, insulation, porosity, and conductivity of the separators 103, 104.

The electrolyte may contain polyhydric alcohols, sulfone compounds, lactone compounds, carbonate compounds, diether compounds of polyhydric alcohols, monohydric alcohols, or the like. These may be used alone or in combination.

The polyhydric alcohol preferably includes at least one of ethylene glycol, diethylene glycol, triethylene glycol, propylene glycol, butanediol, polyalkylene glycol, and glycerin. As the polyalkylene glycol, polyethylene glycol with an average molecular weight of 200 to 1,000 and polypropylene glycol with an average molecular weight of 200 to 5,000 are preferred.

As the lactone compound, γ-butyrolactone, γ-valerolactone, or the like can be used. As the carbonate compound, dimethyl carbonate, diethyl carbonate, ethyl methyl carbonate, ethylene carbonate, propylene carbonate, fluoroethylene carbonate, or the like can be used as a solvent. In particular, ethylene glycol, polyalkylene glycol, γ-butyrolactone, and sulfolane are preferred.

The electrolyte may also include a solute. Examples of solutes that can be used include acid components, base components, salts of acid components and base components, nitro compounds, or phenolic compounds.

The acid component may be an organic acid, an inorganic acid, or a composite compound of an organic acid and an inorganic acid. Examples of organic acids that can be used include carboxylic acids such as phthalic acid, isophthalic acid, terephthalic acid, maleic acid, succinic acid, glutaric acid, adipic acid, benzoic acid, 4-hydroxybenzoic acid, 1,6-decanedicarboxylic acid, 1,7-octanedicarboxylic acid, or azelaic acid. Examples of inorganic acids that can be used is such as boric acid, phosphoric acid, phosphorous acid, hypophosphorous acid, phosphate esters, or phosphate diesters.

Examples of composite compounds of organic acids and inorganic acids that can be is such as borodisalicylic acid, borodisalic acid, or borodiglycolic acid.

The base component may be primary, secondary, or tertiary amines, quaternary ammonium, or quaternized amidinium. Examples of primary, secondary, or tertiary amines are such as methylamine, dimethylamine, trimethylamine, ethylamine, diethyl amine, triethyl amine, ethylene diamine, N,N-diisopropylethylamine, tetramethylethylene diamine, hexamethylenediamine, or aniline. Examples of quaternary ammoniums are such as tetramethyl ammonium, triethylmethyl ammonium, or tetraethyl ammonium. Examples of quaternized amidiniums are such as ethyldimethyl imidazolinium and tetramethyl imidazolinium.

The conductive polymer is not particularly limited as long as it is a polymer that is conductive. For example, at least one polymer selected from the group consisting of polythiophene, polypyrrole, polyaniline, and derivatives thereof may be used. The conductive polymer typically used is polyethylenedioxythiophene (PEDOT) doped with at least one acid selected from the group consisting of p-toluenesulfonic acid and polystyrenesulfonic acid (PSS).

### (Winding Structure)

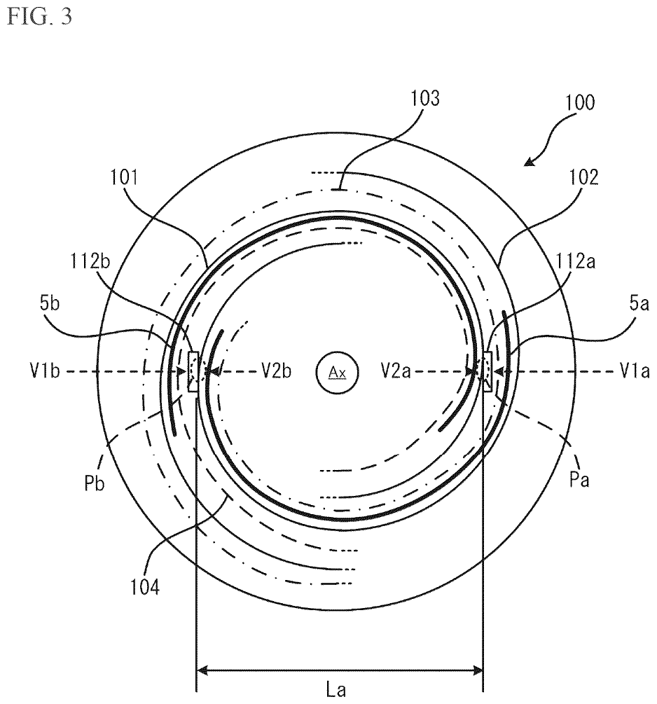

FIG. 3 is a schematic cross-sectional view of an example of the winding structure of the wound body 100 taken along line A-A in FIG. 2. In FIG. 3, components common to FIG. 2 are designated by the same reference numerals and will not be described further. FIG. 3 partially illustrates the anode foil 101, the cathode foil 102, and the separators 103 and 104 wound around a substantially cylindrical winding core Ax. In the following description, the battledore portion 112 on the anode terminal side will be referred to as a battledore portion 112a, and the battledore portion 112 on the cathode terminal side will be referred to as a battledore portion 112b. Note that battledore portion 112a is an example of an anode connection terminal, and the battledore portion 112b is an example of a cathode connection terminal.

The anode foil 101 and the cathode foil 102 are wound with the separators 103 and 104 on opposite sides of each other. The separators 103 and 104 are wound on opposite sides of the anode foil 101 and the cathode foil 102, sandwiching them between them. The separator 103 is an example of a first separator, and the separator 104 is an example of a second separator.

The battledore portion 112a is crimped and connected to a position Pa of the anode foil 101, and the battledore portion 112b is crimped and connected to a position Pb of the cathode foil 102. The positions Pa and Pb are symmetrical with respect to, for example, the winding core Ax. The distance La between the battledore portions 112a and 112b is determined based on the design of the aluminum electrolytic capacitor 1. The respective plate surfaces of the battledore portions 112a and 112b face the outside of the electrolytic capacitor element 10 when viewed from the winding core Ax.

The battledore portion 112a is provided on the outer surface of the anode foil 101 and is crimped to the inner surface of the anode foil 101. The battledore portion 112b is provided on the outer surface of the cathode foil 102 and is crimped to the inner surface of the cathode foil 102. The separator 103 is disposed between the outer surface of the anode foil 101 and the inner surface of the cathode foil 102, and the separator 104 is disposed between the inner surface of the anode foil 101 and the outer surface of the cathode foil 102.

As a result, the separator 103 faces the plate surface of the battledore portion 112a and the crimped connection portion of the battledore portion 112b. Furthermore, the separator 104 faces the plate surface of the battledore portion 112b and the crimped connection of the battledore portion 112a. Therefore, if external force is applied to the battledore portion 112a, 112b during the manufacturing process of the aluminum electrolytic capacitor 1, the thinner the separators 103, 104 are, the more likely they are to be damaged at the contact portions between the battledore portions 112a, 112b and the crimped connection on their back surfaces.

Therefore, insulating sheets 5a, 5b are wound within the wound body 100 so as to face the position Pa of the anode foil 101 and the position Pb of the cathode foil 102 on the separators 103, 104, respectively. As a result, the tensile strength of the separators 103, 104 is increased compared to when the insulating sheets 5a, 5b are not present, and damage to the separators 103, 104 can be suppressed even when pressure is applied to the separators 103, 104 from the battledore portions 112a, 112b and the crimped connections on their back surfaces. The insulating sheet 5a is an example of a first insulating material, and the insulating sheet 5b is an example of a second insulating material.

For example, the insulating sheet 5a is disposed between the separator 103 and the cathode foil 102, and the insulating sheet 5b is disposed between the separator 104 and the anode foil 101. The insulating sheets 5a, 5b contain, for example, the same fibers as the separators 103, 104, or a nonwoven fabric made from a blend of two or more fibers, so as to retain a sufficient amount of electrolyte and conductive polymer. Furthermore, the thickness of the insulating sheets 5a, 5b is, for example, 30 μm or more, and the density of the insulating sheets 5a, 5b is, for example, 0.4 g/cm³.

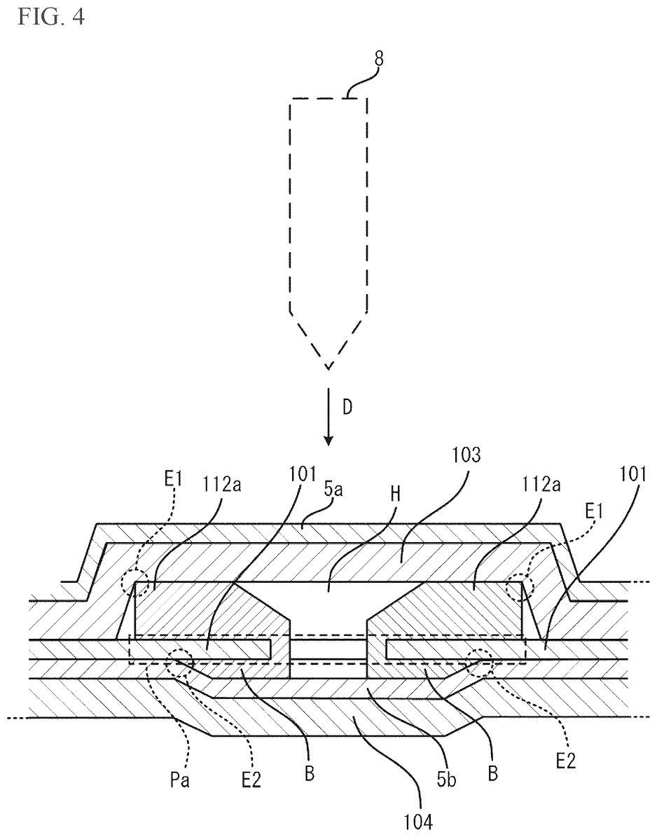

FIG. 4 is a cross-sectional view of an example of the winding structure near the battledore portion 112a. Specifically, FIG. 4 illustrates an enlarged view of the vicinity of the battledore portion 112a in FIG. 2. In this embodiment, the battledore portion 112a is illustrated, but the vicinity of the battledore portion 112b also has a similar winding structure.

In the center of the width of the battledore portion 112a, an opening H is provided that penetrates the entire anode foil 101 in the thickness direction. The opening H is formed by piercing needle-shaped members 8 through multiple points in the battledore portion 112a when the battledore portion 112a is crimped to the position Pa on the anode foil 101 (see arrows D). As a result, burrs B are formed on the battledore portion 112a on the opposite side of the anode foil 101 due to the penetration of the needle-shaped members 8. The burrs B are pushed outward from the opening H, sandwiching the anode foil 101 between the battledore portion 112a and the battledore portion 112a.

In this way, the battledore portion 112a is crimped to the anode foil 101 by the burrs B that penetrate the anode foil 101. Similarly, the battledore portion 112b is crimped to the cathode foil 102 by a burr at the end that penetrates the cathode foil 102.

The battledore portion 112a is covered by the insulating sheet 5a, and the burr B is covered by the insulating sheet 5b. The insulating sheet 5a overlaps the separator 103, and the insulating sheet 5b overlaps the separator 104. This improves the tensile strength of the separators 103 and 104. Therefore, for example, the risk of a corner E1 of the board surface of the battledore portion 112a damaging the separator 103 is reduced, and the risk of a tip E2 of the burr B damaging the separator 104 is reduced.

In this embodiment, the insulating sheet 5a covers the battledore portion 112a via the separator 103, and the insulating sheet 5b directly covers the burr B, but this is not limiting. Even if the insulating sheet 5a directly covers the battledore portion 112a and the insulating sheet 5b covers the burrs B via the separator 104, the tensile strength of the separators 103 and 104 is similarly improved. However, from the perspective of preventing the burrs B from breaking through the separators 103 and 104, it is preferable for the insulating sheets 5a and 5b to directly contact the burrs B.

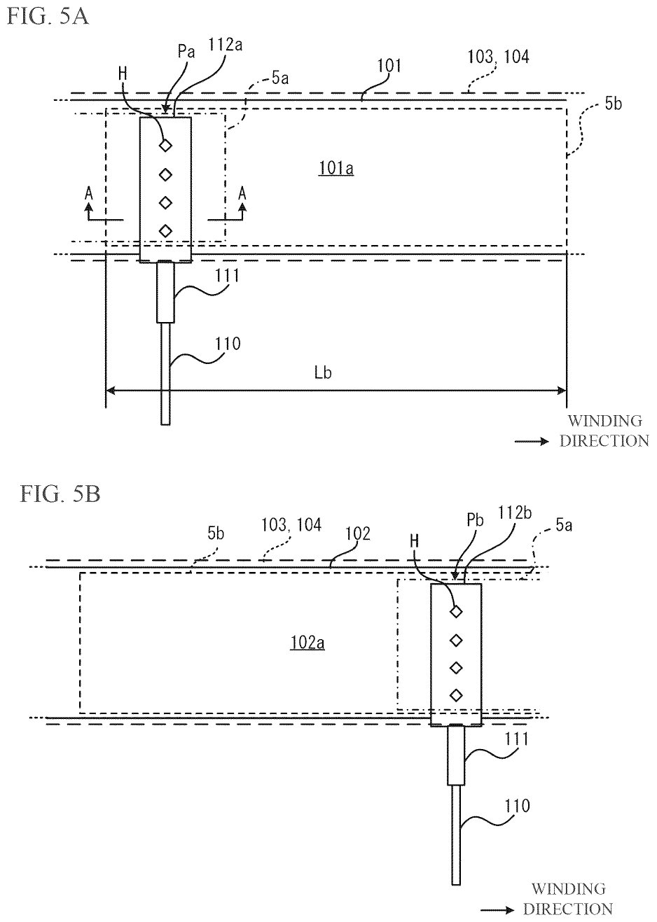

FIG. 5a and FIG. 5b are front views of outer surfaces 101a and 102a of the anode foil 101 and the cathode foil 102, respectively, unfolded in the winding direction. FIG. 5a and FIG. 5b illustrate the anode foil 101 and the cathode foil 102, respectively, when viewed along arrows V1a and V1b in FIG. 3, with the battledore portions 112a and 112b, respectively. The battledore portion 112 a is connected to the outer surface 101a of the anode foil 101, and the battledore portion 112 b is connected to the outer surface 102a of the cathode foil 102.

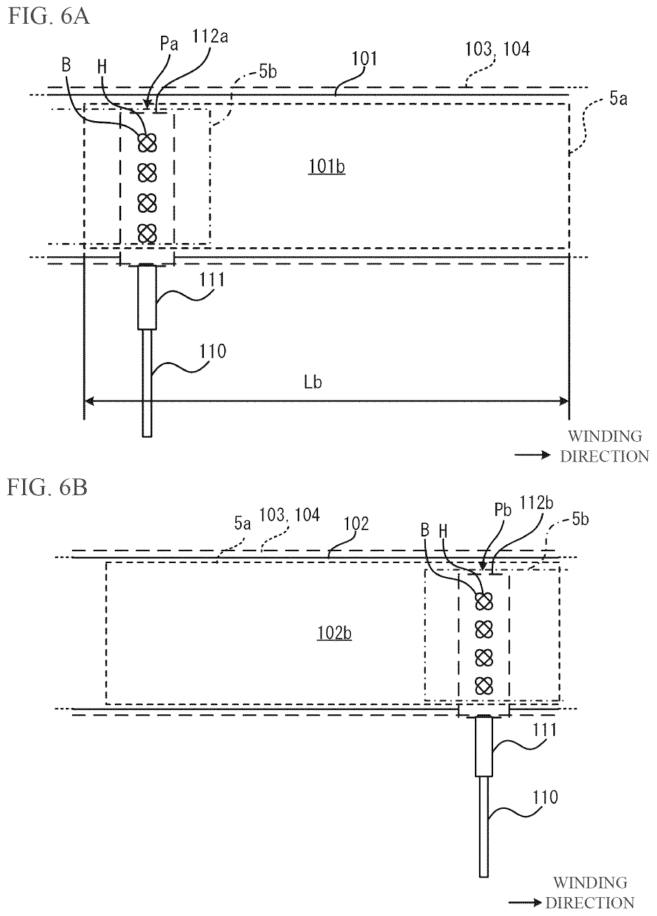

Furthermore, FIG. 6a and FIG. 6b are front views of inner surfaces 101b and 102b of the anode foil 101 and the cathode foil 102, respectively, unfolded in the winding direction. FIG. 6a and FIG. 6b illustrate the anode foil 101 and the cathode foil 102, respectively, when viewed along arrows V2a and V2b in FIG. 3, illustrating the burrs B on the backsides of the battledore portions 112a and 112b, respectively. The burr B of the battledore portion 112a is provided on the inner surface 101b of the anode foil 101, and the burr B of the battledore portion 112b is provided on the inner surface 102b of the cathode foil 102.

FIG. 5a, FIG. 5b, FIG. 6a, and FIG. 6b focus on the overlapping areas between the anode foil 101 and the cathode foil 102 and the insulating sheets 5a, with the insulating sheet 5b omitted. Also, FIG. 5a, FIG. 5b, FIG. 6a, and FIG. 6b illustrate the anode foil 101 and the cathode foil 102 with the insulating sheets 5a aligned in the winding direction (horizontal direction on the page).

Each of the insulating sheets 5a, 5b is provided for each of the separators 103, 104, respectively. The length Lb of the insulating sheets 5a, 5b in the winding direction is set so that, when wound, they overlap the area between the position Pa of the anode foil 101 and the position Pb of the cathode foil 102. As a result, the insulating sheet 5a faces the positions Pa and Pb on the separator 103, respectively, and can cover the battledore portion 112a and the burrs B on the battledore portion 112b. The insulating sheet 5b faces the positions Pa and Pb on the separator 104, respectively, and can cover the battledore portion 112b and the burrs B on the battledore portion 112a.

As a result, the insulating sheets 5a and 5b prevent damage to the separators 103 and 104 caused by the battledore portions 112a and 112b and their burrs B, and also ensure the length Lb spanning the positions Pa and Pb where battledore portions 112a and 112b are located. Therefore, the insulating sheets 5a, 5b have a larger contact area with the separators 103, 104 than if they were individually positioned at the position Pa of the anode foil 101 and the position Pb of the cathode foil 102, and are therefore less likely to become misaligned when wound during the manufacturing process of the aluminum electrolytic capacitor 1.

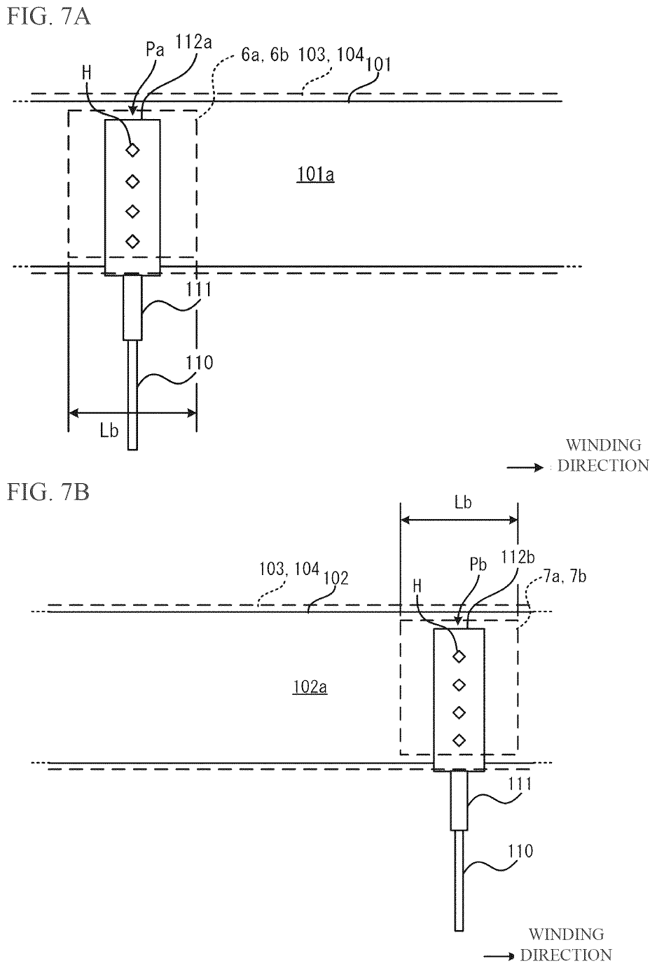

FIG. 7a and FIG. 7b are front views of the outer surfaces of the anode foil 101 and the cathode foil 102 when insulating sheets 6a, 6b, 7a, and 7b are individually positioned on the position Pa of the anode foil 101 and the position Pb of the cathode foil 102, respectively. In FIG. 7a and FIG. 7b, components common to FIG. 5a and FIG. 5b are designated by the same reference numerals, and their description will be omitted.

The insulating sheets 6a, 6b, 7a, and 7b are made of the same insulating material as the insulating sheets 5a and 5b. The insulating sheet 6a covers the battledore portion 112a on the separator 103, and the insulating sheet 6b covers the burrs (not illustrated) on the back side of the battledore portion 112a on the separator 104. The insulating sheet 7a covers the battledore portion 112b on the separator 104, and the insulating sheet 7b covers the burrs (not illustrated) on the back side of the battledore portion 112b on the separator 103.

The insulating sheet 6a covers the battledore portion 112a on the anode foil 101, and does not cover the battledore portion 112b on the cathode foil 102. Therefore, the insulating sheet 6a has the length Lb in the winding direction that only faces the area near the position Pa of the anode foil 101. Furthermore, the insulating sheet 7a covers the battledore portion 112b on the cathode foil 102, and does not cover the battledore portion 112a on the anode foil 101. Therefore, the insulating sheet 6b only has the length Lb in the winding direction, which faces only the area near the position Pb of the cathode foil 102. Similarly, the insulating sheets 6b and 7b also only have the length Lb, which faces only the areas near the positions Pa and Pb.

As such, the length Lb of the insulating sheets 6a, 6b, 7a, and 7b is shorter than the length Lb of the insulating sheets 5a and 5b in the embodiment, so the contact area with the separators 103 and 104 is small, and they are prone to misalignment when wound during the manufacturing process of the aluminum electrolytic capacitor 1.

In contrast, the insulating sheets 5a, 5b of this embodiment each have the length Lb that allows them to face both the positions Pa and Pb on the wound body 100, thereby not only improving the tensile strength of the separators 103, 104 but also preventing misalignment. This reduces damage to the separators 103, 104 and thus reduces degradation of the quality of the electrolytic capacitor element 10.

It is preferable for the length Lb of the insulating sheets 5a, 5b in the winding direction to be three or more times the distance La between the battledore portions 112a and 112b, as this significantly reduces short-circuit defects compared to when the individual insulating sheets 6a, 6b are provided as illustrated in FIG. 7a and FIG. 7b. Furthermore, if the length Lb of the insulating sheets 5a, 5b in the winding direction is 10 times or less the distance La between the battledore portions 112a and 112b, the diameter of the wound body 100 can be kept to an appropriate size, making it easier to house the electrolytic capacitor element 10 in the case 11 and seal the electrolytic capacitor element 10 with the sealing body 12, which is preferable.

In this embodiment, the battledore portions 112a and 112b are arranged on the outer surfaces 101a, 102a of the anode foil 101 and the cathode foil 102, respectively. However, this is not limited to this, and the battledore portions 112a and 112b may also be arranged on the inner surfaces 101b, 102b. Therefore, the insulating sheets 5a, 5b can cover the battledore portion 112a and the burrs B on its back side, or the battledore portion 112b and the burrs B on its back side. For example, the insulating sheet 5a may cover the battledore portion 112b portion and the burrs B on its back side, and the insulating sheet 5b may cover the battledore portion 112a and the burrs B on its back side.

Furthermore, the lengths of the insulating sheets 5a, 5b may be the same or different. For example, by making the insulating sheet 5b on the separator 104 approximately 1.1 times longer than the insulating sheet 5a on the separator 103, the winding precision of the wound body 100 can be improved.

### (Method for Manufacturing an Aluminum Electrolytic Capacitor)

Next, a method for manufacturing the aluminum electrolytic capacitor 1 will be described.

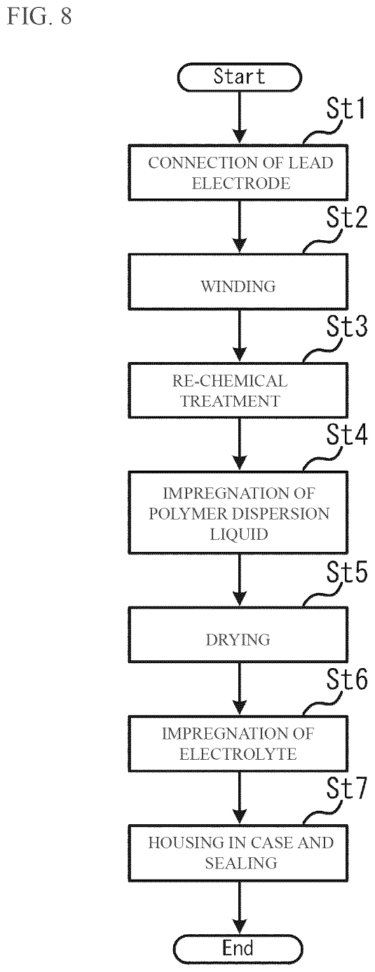

FIG. 8 is a flowchart of an example of the manufacturing process for the aluminum electrolytic capacitor 1. To manufacture the aluminum electrolytic capacitor 1, the anode foil 101, the cathode foil 102, the separators 103 and 104, and the insulating sheets 5a and 5b are prepared.

For example, the thickness of the anode foil 101 is 5 to 200 μm, and the thickness of the separator is 1 to 100 μm. The thickness of the insulating sheets 5a and 5b is 30 μm. Pits are formed on the surfaces of the anode foil 101 and the cathode foil 102 by etching. The anode foil 101 is subjected to a chemical conversion treatment, and a dielectric layer of an oxide film is formed on the etched surface.

First, the lead electrode 19a is crimped to the position Pa on the anode foil 101, and the lead electrode 19b is crimped to the position Pb on the cathode foil 102 (step St1). Next, the anode foil 101, the separator 103, the cathode foil 102, and the separator 104 are stacked in this order and wound, and the outer surfaces are fixed with a stop tape to form the wound body 100 (step St2). The anode foil 101 and the cathode foil 102 are wound with the separators 103 and 104 interposed between them, and the separators 103 and 104 are wound on opposite sides of the anode foil 101 and the cathode foil 102. This forms the electrolytic capacitor element 10, ready for immersion in the conductive polymer solution and electrolyte solution.

Furthermore, in the process of forming the wound body 100, the insulating sheet 5a is wound around the wound body 100 so as to face the positions Pa and Pb on the separator 103, and the insulating sheet 5b is wound around the wound body 100 so as to face the positions Pa and Pb on the separator 104. The insulating sheet 5b is positioned on the opposite side of the insulating sheet 5a, with the anode foil 101 and the cathode foil 102 sandwiched between them.

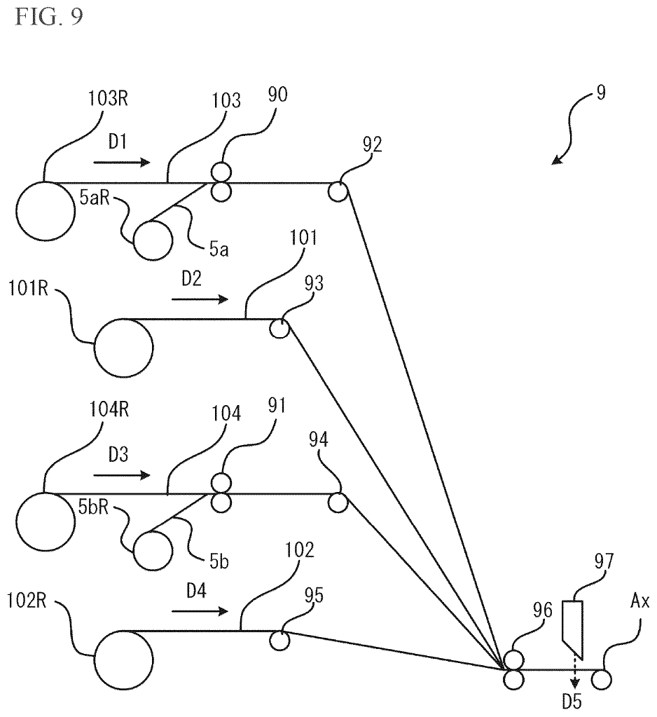

FIG. 9 illustrates an example of the schematic configuration of a winding device 9 that produces the wound body 100. The winding device 9 has a reel 101R on which the anode foil 101 is wound, a reel 102R on which the cathode foil 102 is wound, a reel 103R on which the separator 103 is wound, a reel 104R on which the separator 104 is wound, a reel 5aR on which the insulating sheet 5a is wound, and a reel 5bR on which the insulating sheet 5b is wound.

The anode foil 101, the cathode foil 102, and the separators 103 and 104 are pulled-out in pull-out directions D1 to D4 via rollers 93, 95, 92, and 94, respectively. The anode foil 101, the cathode foil 102, and the separators 103 and 104 are overlapped by passing through a downstream clamp roller 96 and are spirally wound around the circumferential surface of winding core Ax, as illustrated in FIG. 3. A cutter 97 is disposed upstream of the winding core Ax. After a predetermined length of the anode foil 101, the cathode foil 102, and the separators 103 and 104 has been wound, the cutter 97 moves in a direction D5 substantially orthogonal to the winding direction to cut the anode foil 101, the cathode foil 102, and the separators 103 and 104.

The insulating sheet 5a is pulled out from the reel 5aR and superimposed on the separator 103 by the clamp roller 90, located upstream of the roller 92. The insulating sheet 5b is pulled out from the reel 5bR and superimposed on the separator 104 by the clamp roller 91, located upstream of the roller 94. The reel 5aR feeds the insulating sheet 5a so that the insulating sheet 5a is superimposed only on a predetermined area of the anode foil 101, and a reel 5aL feeds the insulating sheet 5b so that the insulating sheet 5b is superimposed only on a predetermined area of the cathode foil 102.

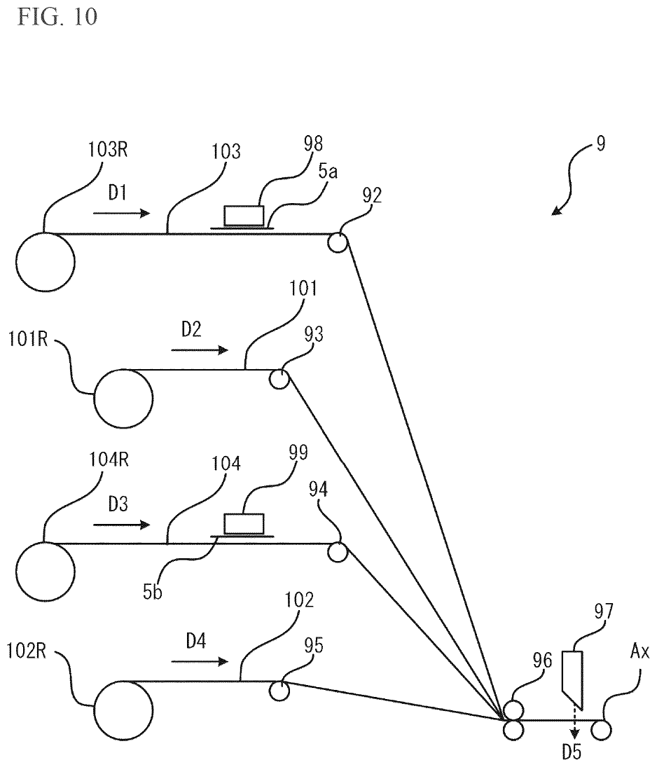

FIG. 10 illustrates another example of the schematic configuration of the winding device 9 that produces the wound body 100. In FIG. 10, components common to FIG. 9 are assigned the same reference numerals, and their description will be omitted.

The winding device 9 has attaching devices 98, 99 for the insulating sheets 5a, 5b. The attaching device 98 is located upstream of the roller 92 and attaches the insulating sheet 5a to the anode foil 101. The attaching device 99 is located upstream of the roller 94 and attaches the insulating sheet 5b to the cathode foil 102. An acrylic or other adhesive is pre-applied to the attachment surfaces of the insulating sheets 5a, 5b. By attaching the insulating sheets 5a, 5b to the anode foil 101 and the cathode foil 102 in this manner, misalignment of the insulating sheets 5a, 5b is more effectively suppressed.

Referring back to FIG. 8, the wound body 100 is immersed in, for example, an ammonium phosphate aqueous solution, and a predetermined voltage is applied to the anode foil 101 for re-chemical treatment, repairing the oxide film and forming a dielectric layer on the cut surface of the anode foil 101 (Step St3).

Next, the wound body 100 is immersed in a conductive polymer dispersion in a reduced pressure atmosphere, impregnating the wound body 100 with the dispersion (Step St4). Note that instead of a conductive polymer dispersion, the wound body 100 may be immersed in a solution containing a conductive polymer.

Next, the wound body 100 is dried (Step St5). At this time, the water solvent in the conductive polymer liquid impregnated in the separators 103 and 104 within the wound body 100 evaporates, forming a conductive polymer layer.

Next, the electrolytic capacitor element 10 is impregnated with an electrolyte in a reduced pressure atmosphere (step St6). The electrolytic capacitor element 10 is then housed in the case 11 and sealed with the sealing body 12 (step St7). At this time, the lead electrodes 19a, 19b extending from the electrolytic capacitor element 10 are inserted into the through-holes 120 in the sealing body 12. An aging treatment may then be performed while applying a rated voltage to the aluminum electrolytic capacitor 1. This completes the manufacturing process for the aluminum electrolytic capacitor 1.

### Example

Using the above manufacturing process, for each of samples No. 1 to 4, 10,000 numbers of the aluminum electrolytic capacitors 1 were manufactured. Furthermore, for evaluation of samples No. 1 to 4, a comparative sample, sample No. 5, was manufactured. The sample No. 5 was a comparative sample. Unlike the samples No. 1 to 4, the sample No. 5 has a total of four of the insulating sheets 6a, 6b, 7a, and 7b, respectively covering battledore portion 112a and the burrs B on its back side and the battledore portion 112b and the burrs B on its back side, similar to the configuration illustrated in FIGS. 7a and 7b. In contrast, the samples No. 1 to 4 have a total of two insulating sheets: the insulating sheet 5a covering battledore portions 112a and 112b, and the insulating sheet 5b covering the burrs B on the back sides of battledore portions 112a and 112b.

The diameter of the case 11 for the samples No. 1 to 5 was 18 mm, and the height of the samples No. 1 to 5 was 40 mm. The thickness of the anode foil 101 was 120 μm, the thickness of the separators 103 and 104 was 30 μm, and the thickness of the insulating sheets 5a, 5b, 6a, and 6b was 40 μm.

TABLE 1

| | INSULATING SHEET | | DISTANCE La | | | | | | |
|---|---|---|---|---|---|---|---|---|---|
| | | NUMBER | BETWEEN | | DEFECT | IMPROVE- | ELEMENT | DIAMETER | |
| SAMPLE | LENGTH | (NUMBER | TERMINALS | | RATE | MENT | DIAMETER | INCREASE | |
| No. | Lb (mm) | OF SHEET) | (mm) | Lb/La | (%) | RATE (%) | (mm) | RATE (%) | JUDGE |
| 1 | 20.0 | 2 | 8.0 | 2.5 | 2.15 | 40 | 15.68 | −0.1 | Δ |
| 2 | 24.0 | 2 | | 3.0 | 1.54 | 57 | 15.70 | 0 | ◯ |
| 3 | 80.0 | 2 | | 10.0 | 0.42 | 88 | 15.97 | +1.7 | ◯ |
| 4 | 88.0 | 2 | | 11.0 | 0.37 | 90 | 16.01 | +2.0 | Δ |
| 5 | 10.0 | 4 | | 1.25 | 3.61 | — | 15.70 | — | — |

Table 1 shows various parameters and evaluation results for the samples No. 1 to 5. The samples No. 1 to 4 used two sheets, the insulating sheets 5a and 5b. The length Lb of the insulating sheets 5a and 5b of the sample No. 1 was 20.0 mm, the length Lb of the insulating sheets 5a and 5b of the sample No. 2 was 24.0 mm, the length Lb of the insulating sheets 5a and 5b of the sample No. 3 was 80.0 mm, and the length Lb of c of the sample No. 4 was 88.0 mm.

The sample No. 5 uses four sheets, the insulating sheets 6a, 6b, 7a, and 7b. The length Lb of the insulating sheets 6a, 6b, 7a, and 7b in the sample No. 5 was 10.0 mm. The distance between the lead electrodes 19a and 19b (inter-electrode distance) La in the samples No. 1 to 5 was 8.0 mm.

The ratio (Lb/La) of the length Lb of the insulating sheets 5a, 5b, 6a, and 6b to the inter-terminal distance La is calculated from the above values. The sample No. 1 has an Lb/La ratio of 2.5, the sample No. 2 has an Lb/La ratio of 3.0, the sample No. 3 has an Lb/La ratio of 10.0, the sample No. 4 has an Lb/La ratio of 11.0, and the sample No. 5 has an Lb/La ratio of 1.25.

The samples No. 1 to 5 were evaluated by measuring the short-circuit defect rate (failure rate) (%) and the diameter (element diameter) (mm) of the wound body 100. The defect rate was measured using the short-circuit detection mechanism of the aging machine, and the element diameter was measured using a vernier caliper.

The defect rate for the sample No. 1 was 2.15(%), the defect rate for the sample No. 2 was 1.54(%), the defect rate for the sample No. 3 was 0.42(%), and the defect rate for the sample No. 4 was 0.37(%). The defect rate for the sample No. 5 was 3.61(%). The sample No. No. 5 had the individual insulating sheets 6a, 6b, 7a, and 7b attached to the battledore portions 112a and 112b and their burrs B, and had the shortest length Lb, which made the insulating sheets 6a, 6b, 7a, and 7b prone to misalignment and resulted in the highest defect rate.

The improvement rate (%) indicates the ratio of the defect rates of the samples No. 1 to 4 to the defect rate of the sample No. 5. The sample No. 1 had the shortest length Lb of the insulating sheets 5a and 5b among the samples No. 1 to 4, resulting in the lowest improvement rate of 40%. The sample No. 4 had the longest length Lb of the insulating sheets 5a and 5b among the samples 1 to 4, resulting in the highest improvement rate of 90%. The sample No. 2 had an improvement rate of 57%, and the sample No. 3 had an improvement rate of 88%.

As described above, the longer the length Lb of the insulating sheets 5a and 5b, the more effectively the positional misalignment is suppressed. However, the diameter (element diameter) of the wound body 100 also increases, making it more difficult to accommodate the electrolytic capacitor element 10 in the case 11 and seal the electrolytic capacitor element 10 with the sealing body 12. The element diameter of the sample No. 5 was 15.70 mm. Since the length Lb of the insulating sheets 5a and 5b of the sample No. 1 was the shortest among the samples No. 1 to 4, the element diameter was the smallest at 15.68 mm. Since the length Lb of the insulating sheets 5a and 5b of the sample No. 4 was the longest among the samples No. 1 to 4, the element diameter was the largest at 16.01 mm. Furthermore, the element diameter of the sample No. 2 was 15.70 mm, and the element diameter of the sample No. 3 was 15.97 mm.

The diameter increase rate (%) indicates the ratio of the element diameter of the samples No. 1 to 4 to that of the sample No. 5. Based on the element diameter measurement results, the diameter increase rate of the sample No. 1 was −0.1%, the diameter increase rate of the sample No. 2 was 0%, the diameter increase rate of the sample No. 3 was +1.7%, and the diameter increase rate of the sample No. 4 was +2.0%.

The samples No. 1 to 4 were judged based on the evaluation results of the improvement rate and the diameter increase rate. A judge of “∘” (Excellent) was given if the two conditions of the improvement rate ≥50% and the diameter increase rate <2.0% were met. A judge of “Δ” (Good) was given if only one of the two conditions was met. Based on the above criteria, the samples No. 1 and 4 were judged as “Δ” while the samples No. 2 and 3 were judged as “∘”.

From the above, it is preferable that Lb/La be 3.0 or greater from the perspective of the defect rate, and 10.0 or less from the perspective of element diameter.

Although the embodiments of the present invention have been described in detail above, the present invention is not limited to the specific embodiments, and various modifications and changes are possible within the scope of the gist of the present invention described in the claims.

1. An electrolytic capacitor element comprising:
a wound body in which an anode foil and a cathode foil are wound with a first separator and a second separator on opposite sides of each other;
an anode connection terminal connected to a first position of the anode foil;
a cathode connection terminal connected to a second position of the cathode foil;
a first insulating material that is wound within the winding body so as to face the first position and the second position on the first separator; and
a second insulating material that is wound in the winding body on the second separator so as to face the first position and the second position, and is disposed so that the anode foil is interposed between the first insulating material and the second insulating material at the first position, and the cathode foil is interposed between the first insulating material and the second insulating material at the second position.

2. The electrolytic capacitor element as claimed in claim 1,
wherein a length of at least one of the first insulating material and the second insulating material in a winding direction is three times or more a distance between the anode connection terminal and the cathode connection terminal.

3. The electrolytic capacitor element as claimed in claim 1,
wherein a length of at least one of the first insulating material and the second insulating material in a winding direction is 10 times or less a distance between the anode connection terminal and the cathode connection terminal.

4. The electrolytic capacitor element as claimed in claim 1,
wherein at least one of the first insulating material and the second insulating material contains a fiber.

5. The electrolytic capacitor element as claimed in claim 1,
wherein:
each of the anode connection terminal and the cathode connection terminal has a burr at an end thereof that penetrates the anode foil and the cathode foil, respectively, and is crimped and connected to each of the anode foil and the cathode foil by the burr; and
at least one of the first insulating material and the second insulating material covers the burr of at least one of the anode foil and the cathode foil.

6. The electrolytic capacitor element as claimed in claim 1,
wherein the first insulating material is attached to the first separator.

7. The electrolytic capacitor element as claimed in claim 1,
wherein the second insulating material is attached to the second separator.

8. A manufacturing method of an electrolytic capacitor element, comprising:
connecting an anode connection terminal to a first position of an anode foil and connecting a cathode connection terminal to a second position of a cathode foil; and
winding the anode foil and the cathode foil with a first separator and a second separator interposed therebetween on opposite sides to form a wound body,
wherein, in the forming of the wound body, a first insulating material is wound in the wound body so as to face the first position and the second position on the first separator, and a second insulating material is wound in the wound body on the second separator so as to face the first position and the second position, and is disposed so that the anode foil is interposed between the first insulating material and the second insulating material at the first position, and the cathode foil is interposed between the first insulating material and the second insulating material at the second position.
